(19) United States
(12) Patent Application Publication
(10) Pub. No.: US 2012/0006808 A1
(43) Pub. Date: Jan. 12, 2012

(54) Thermal Countermeasures Technology Electro-Resistive Heating Materials and Composites

(76) Inventor: David A. Young, Delaware, OH (US)

(21) Appl. No.: 13/163,492

(22) Filed: Jun. 17, 2011

Related U.S. Application Data
(60) Provisional application No. 61/356,289, filed on Jun. 18, 2010.

(51) Int. Cl. H05B 3/02; B29C 65/02

(52) U.S. Cl. 219/541; 29/592.1; 156/60

(57) ABSTRACT

An electrically conductive thermoplastic structure comprising a resin mixture having conductive, bonding and resistive properties, and at least two metal particles. The structure is formed by spraying the resin mixture and the metal particles in combination with an adhesive on to a non-conductive backing and heating to self-level and cure the structure. The resulting structure has dielectric properties, which can be regulated by a computer to provide controlled heating for a wide range of applications, such as aircraft deicing.

### BACKGROUND AND SUMMARY OF THE INVENTION

The present invention relates to Thermal Countermeasures Technology (TCT) electro-resistive heating materials/composites and more particularly to electro-resistive heating materials and composites used to eliminate ice.

TCT applied to various substrate surfaces diminishes and eliminates ice accumulation. The electro-resistive capabilities of TCT provide a permanent solution for anti-icing and deicing. For aircraft, as an example, TCT works in pre-flight, in-flight and post-flight operations as a permanent thermal application replacing the temporary glycol and thermal hanger current applications.

Electro-resistive conductive composite materials (ERCCM) are micrometer thin film heating technologies that operate through linear electrically attached provisions. ERCCM thin film technology promotes heating upon areas needing heating assistance that could possibly have weight constraints. This application is one of several components with relationships to thermal countermeasures technologies.

Once applied to substrate surfaces and energized with electricity the ERCCM heats to a self limiting temperature or is computer assisted to control applied zones or areas needing heat to diminish or prevent ice accumulation. Transportation industries are primary of many applications focusing upon applying ERCCM to the exterior surfaces. Energizing the ERCCM in a linear means creates a thin film heater technology that can be applied upon almost any surface to diminish and prevent ice and snow accumulation. Aero-Space applications would reduce if not completely remove hazardous glycol repeat applications and/or treatments. ERCCM would be similar in characteristics in technology such as a rear-window defroster used in the automotive industries.

### BRIEF DESCRIPTION OF THE DRAWING

FIG. 1 is a top view of embodiment of the invention showing the thin film electro-resistive composite bonded to a substrate, with docking harness and connectors.

FIG. 2 is an alternate view of the invention showing the thin film electro-resistive composite bonded to the substrate, docking harness, and connectors.

FIG. 3 is diagram of an embodiment used in an aero-space application.

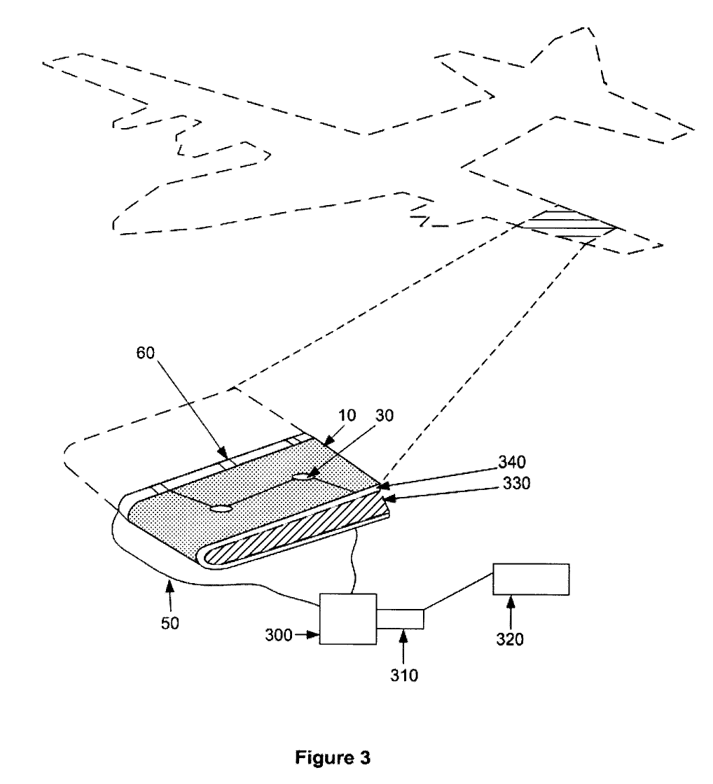

### DETAILED DESCRIPTION OF THE INVENTION

The present invention is an electro-resistive conductive composite material micrometer thin film heating technology that operates linear electrically and producing a heating result. Electro-resistive thin film technology promotes heating in areas that need micro thin applications and that have weight constraints and or considerations. Coatings are composed to accept electrical charges to produce heat, computer assisted for an additional controlling feature or simply self limited in heating capabilities due to composite thickness or controlled power distributions.

This invention is comprised of the following: (1) a substrate surface is treated to receive electro-resistive composite application; (2) a TCT electro-resistive micrometer film is applied; (3) hardware for material connections and surface controls for temperature are connected; (4) the TCT surface is painted; and (5) a polarization protection system is applied to the painted surface.

ERCCM are comprised of micrometer materials possessing capabilities of accepting, harnessing, collecting, resisting and forwarding energy and heat, being latent or traveling. ERCCM are capable of being built in right angles, flexible and possess the capabilities of working around voids such as tears and hole due to damage, including foreign object damage. Many applications are possible such as screen printing, atomized sprays, peal and stick such as a decal or sticker and direct substrate applications such as but not limited to mixing electro-resistive composite materials in the mix of composites that make up various substrate compositions. In an embodiment, the present invention is blended into the substrate instead of topically applied.

Some of the functions of the present invention are (1) to create enough heating capabilities within self limiting thickness ranges to take upon tasks of rapidly changing conditions where ice and snow have a possibility of existing or accumulating, (2) self limiting in temperatures or through the use of temperature controlling devices such as thermostats, thermocouples and other temperature assisting equipment and devices, (3) applied to critically identified areas to function as a thin film heater and be receptive to computer assistance, and (4) additional monitoring devices that detect and reveal substrate surface conditions and/or performances.

Transportation industries are some of the many applications that would use this electro-resistive material using the benefit of thin film technologies, because the invention is light weight, durable yet using minimal power to create a substrate surface that yields the potential of preventing ice accumulations in many stages, such as but not limited to pre-flight, in-flight and post-flight operations for aircraft and devices related to the aerospace community, trucking trailer tops, bottoms and sides, entire automotive shells, train and rail anti-icing and deicing applications to rail cars, engines, bridges and rail systems. Additionally, the invention could be applied to roofing systems, power transmissions cables and communications lines, shell or exterior applications to pipe lines (such as but not limited to the Alaska Pipe Line) maritime exterior surfaces. The invention can be applied to any surface that has a need or a call for heating necessities with thin film technologies. Anything that could accumulate ice and snow, also includes engines on any vehicle, wind turbine propellers, aircraft propellers, helicopter propellers, blimp exterior skin surfaces, busses and commuter rail systems including rail cars and railroad tracks. Additionally, interior applications where ERCCM could be applied to produce heat such as, but not limited to, exterior siding & interior walls and windows for households, office buildings, restaurants, shipping containers, hospitals, hotels, motels, construction trailers, mobile and manufactured homes, rail cars and tractor trailers, flooring systems, doors, work-shop walls, factory walls and ceilings, bucket truck lifts and medical tables.

Interfacing components with monitoring equipment allows the operator of any such equipment the luxury of knowing equipment is working and changing to meet the environmental conditions. The invention may also be scaled using nanometer technology, thus reducing the amount of material in mill thicknesses and property evaluations.

Necessary elements in the invention are the components and composition of composite materials to create the electro-resistive material. In an embodiment, the invention comprises about 65% metal flake, about 30% resin, and about 5% bonding agent. In an embodiment, the invention comprises: a) a base, b) a conductive resin layer comprising metal flakes, such as but not limited to at least two of copper, silver, aluminum, manganese and nickel, and c) a bonding resin comprising co-blended adhesives droplets sheltering the conductive resin, providing a die-electric bonding. Bonders include thin films of metal and metal oxides that provide enhanced adhesion, such as nichrome and the like. Resins can both be bonded and cured to the adhesives using either ultraviolet light or controlled oxygen applications. Anyone trained in the art would recognize the need to adapt this formula to different applications. Examples of conductive resins include polycarbonates, polyolefins such as polyethylene and polypropylene, polyacetals, acrylics, vinyls, fluoropolymers, polyamides, polyesters, polysulfones and the like. Examples of bonding resins include epoxy, polyester and the like. Examples of conductive resins include polyphenylenesulfide, polyimide amide, polyimide, polyether ether ketone and the like.

The present invention further comprises a polymeric material, such as a silicone rubber, a silicone gel, polyethylene, polypropylene, an elastomer, natural or synthetic rubber, epoxy, and the like. The polymeric material is any suitable mixture that sprays well, sticks well, keeps the metal particles firmly fixed to the substrate, and cures quickly. Plasticizer additives such as silicone based modifiers in the range of approximately 0% to 15% may be added for flexibility.

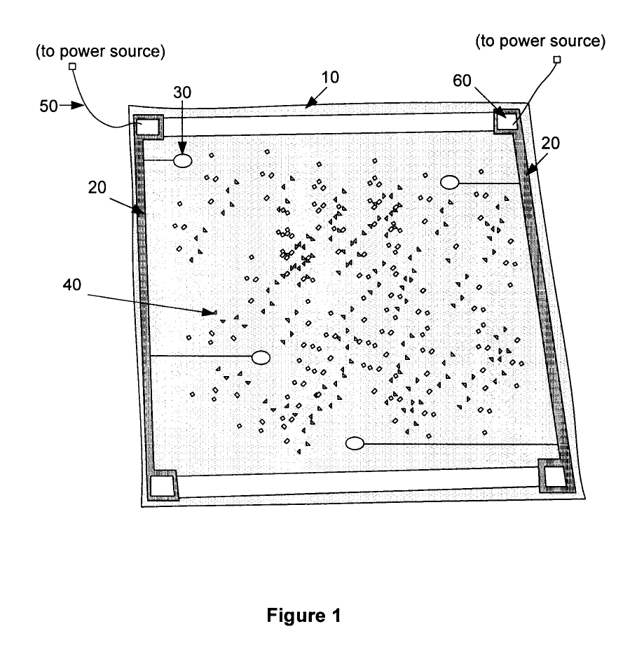

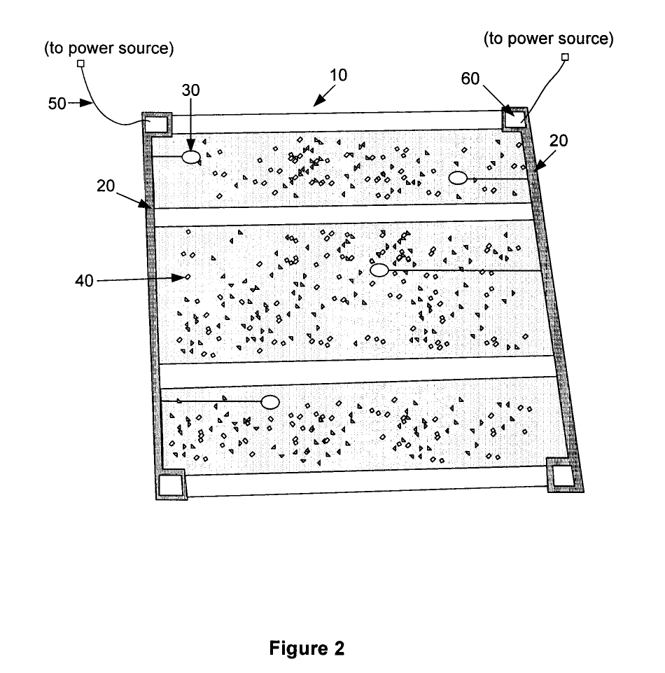

In an embodiment shown in FIGS. 1 and 2, the black material is primarily opaque to infrared radiation. The material is made from micro sized copper and silver particles with a small trace of an epoxy based material to unite the copper and silver. Metals are added in sufficient concentration so that the flecks or specs (particles) are touching each other. The thickness of combined resins have a starting range of about 3 micrometers which reaches self leveling in temperatures of about 125 degrees Fahrenheit. The desired temperature range for use of the invention for anti-icing would be anywhere in a host environment starting at about 33 degrees Fahrenheit and adjusting as necessities present a higher temperature range through a rheostat or potentiometer to send more energy through. Higher temperatures are required for creating thicker applications in order for the composite to self level. The copper, silver and nickel flakes and resins are sprayed upon a polyimide based film, such as Kapton® (developed by DuPont). The film has a unique combination of electrical, thermal, chemical and mechanical properties that are retained over a wide range of industrial environments and applications.

In an embodiment, a colorless adhesive is applied to bond the electro-resistive composite materials to a backing which stabilizes the ERCCM. In an embodiment, the ERCCM has a composition of copper estimated weight percentage of about 98%, aluminum estimated weight percentage of about 0.7%, manganese estimated weight percentage of about 0.2% and silver estimated weight percentage of about 0.7%.

The resulting structure is micrometers in thickness, and may be vary in thickness as required by various substrate/straight surfaces on which the structure is applied.

Connecting to additional ERCCM is through miniature thin-film electrical connectors that are of similar thickness to the ERCCM and regulatory devices are connected through the use of these thin-film connectors. Optional elements are computer assistance and monitoring gauges with a power-on & power-off switch, enhancing the products capabilities there is a preference of being applied during the green stage of substrate manufacturing prior to being primered or painted.

To prepare the invention, the following components are assembled:

a clean virgin or virgin prepared (without impurities) substrate ready to accept an adhesive or a dielectric elastomeric to bond the thin film electro-resistive composites, connecting any related wires, docking harnesses, connectors, temperature controls/controllers, sensing equipment, sensors and monitoring devices, covering with industry standard primers and paints and cured (final protective coating) with polytetrofluoroethylene monomonolectular surface protection chemistry (PTFE), to protect the painted surface while it allows the electro-resistive surface better protection from elements related in atmospheric conditions and typical environmental challenges in all levels of spheres, related to altitudes and depths.

Applied energy/electricity within ranges of 6, 12, or 24 volts direct current and up to 100 volts direct current, and from 120 volts alternating current to 220 volts alternating current, depending on the application and the application intentions and achievable goals is introduced to the ERCCM through means of docking stations, connectors and thin-film wiring. Monitoring and regulating devices are also connected to the ERCCM through a series or combination of thin-film connectors, that, once connected, provide connective functionality assistance and performance monitoring, while being protected by primers and/or paints within the industry (standard) applied to and shielded with polytetrofluoroethylene (PTFE) to enhance the performance of painted surfaces thus awarding longevity to the end product.

Effects of heat are calculated by considering the power source and ERCCM length, width and thickness. Thicknesses with composites down to 3 micrometers of ERCCM connected to a power source of 12 volts direct current at 11.4 ohms of resistance upon a 4.5 inch by 4.5 inch ERCCM produced a self limiting 125 degrees Fahrenheit temperature. Upon a work load of frozen CO₂ and H₂0, the ERCCM operates in ranges of minus 74 degrees Fahrenheit without energy passing across the composite surface area. Once energized with 12 volts direct current the ERCCM went from minus 74 Fahrenheit to positive 74 degrees Fahrenheit in under 30 (thirty) seconds and leveled the temperature at positive 74 degrees Fahrenheit while the ambient temperature surrounding the ERCCM maintained minus 74 degrees Fahrenheit.

Once the electricity is introduced to properly reach the desired/intended (module controlled) or manufactured temperature (self limiting through constructed thickness) additional added features such as computer assistance can allow identified (critical) areas to shed or adjust desired temperature ranges by regulating electricity. One of the means of regulating the temperature is through the use of thermostats & thermocouples, another means of regulating temperatures is to energize and shut down specific fields ERCCM is deployed upon for substrate surface heating, anti-icing and deicing.

In that the product is a thin film heater made up of several components that have an end result of a controlled micrometer surface application, product execution using computer and machine assistance seems to have no known boundaries and product manufacturing seems endless in potentials. ERCCM has the capabilities of performing even around voids within the material.

Example: One can poke holes into the ERCCM material and the void has no noticeable effects on the performance of the remaining material. This is exciting speculating military applications as a benefactor.

Enter into a computerized program the necessary composites thickness, length and width of the ERCCM make sure that the cartridges/hoppers for each composite resins has product/s, enter information into computer and the atomized spray is mixed and applied uniformly until the input requirements are satisfied. Feature settings will result in an ERCCM production ready to receive thin-film electrical connectors, temperature regulating and computer assistance devices.

By increasing the size and performance capabilities, and/or adding a larger clean room environment, the invention can perform more services. Mass production of ERCCM using assembly lines and several predetermined programs for repeat sizes and thicknesses is capable to meet market demands.

The end user (using aero-space as an example) would simply need to start up the aircraft which engages the generators (aircraft powered units) and engage (turn on) the anti-icing deicing device provided within the cockpit, the computer assistance and predetermined substrate areas covered with the electro-resistive conductive composites (ERCCM) will be activated and perform with monitoring and limiting devices throughout the duration of the distances traveled or until deactivated.

The invention can be used for anti-icing and deicing of substrate materials such as air-craft, aero-space, trucks (trucking) & trailers, maritime, bridges, storage containers, buildings, residential structures, power & communication transmission cables, automotive, auto-mobile, container shipping, decks, drive lanes, buses, railroad, space exploration, space shuttle, satellites, unmanned aerial vehicles, military object & vehicle deployment and fixed structures, commuter shipping, luxury liners, windows, wall & floor heaters, and anything that could receive an application for needs of thermal assistance to enhance any such property. Anti-ice & deicing is a primary application but items such as the Alaska Pipe-line and other fixed place surfaces needing thermal assistance are target markets and application areas we intend on putting this resource.

The present invention is useful in the bio-medical field for thermal comfort to appendages and the like. Other examples includes used as a roofing system for remote or fixed building locations to prevent snow and ice accumulation upon any part of the structure coated or applied to with ERCCM products. ERCCM coated gutters and storm doors once will no longer have ice accumulation or are compromised with in climate weather related freezing. ERCCM coated power transmission and communications cables exposed to weather conditions would never again have ice accumulation and compromise connections due to weighted cables fatiguing.

The foregoing descriptions of specific embodiments and examples of the present invention have been presented for purposes of illustration and description. They are not intended to be exhaustive or to limit the invention to the precise forms disclosed, and obviously many modifications and variations are possible in light of the above teachings. It will be understood that the invention is intended to cover alternatives, modifications and equivalents. The embodiments were chosen and described in order to best explain the principles of the invention and its practical application, to thereby enable others skilled in the art to best utilize the invention and various embodiments with various modifications as are suited to the particular use contemplated. It is therefore to be understood that within the scope of the appended claims, the invention may be practiced otherwise than as specifically described herein.

I claim:

1. A deicing system comprising:
a structure, the structure having a thickness from about 1 micrometer to about 4 micrometers and comprising: (a) a resin mixture having conductive, bonding and resistive properties, (b) at least two types of metal particles, and (c) a non-conductive backing, the structure formed by spraying the resin mixture and the metal particles in combination with an adhesive onto the backing and heating to self-level and cure the structure, the structure about 65% metal particles, about 30% resin, and about 5% bonding agent, the metal particles selected from the group copper, silver, aluminum, manganese, and alloys thereof,
at least two thin-film electrical connectors connecting the structure to a power source, and
at least one temperature sensor connected to the connectors.

2. The deicing system of claim 1 wherein the structure has a thickness about 3 micrometers.

3. The deicing system of claim 1 wherein the metal particles are about 98 weight percent of copper, about 0.7 weight percent of aluminum, about 0.2 weight percent of manganese and about 0.7 weight percent of silver based on volume.

4. The deicing system of claim 1 further comprising a computer connected to the connectors.

5. A method of forming a deicing assembly comprising the steps of:
1) spraying a resin mixture, at least two metal particles and an adhesive on a non-conductive backing, the metal particles selected from the group copper, silver, aluminum, manganese, and alloys thereof,
2) heating the components of step 1 to self-level and cure the resin mixture and metal particles components into a structure, the structure comprising about 65% metal particles, about 30% resin, and about 5% bonding agent and having a thickness from about 1 micrometer to about 4 micrometers,
3) attaching at least two thin-film electrical connectors connected to a power source to the structure,
4) connecting at least one temperature sensor to the connectors.

6. The deicing assembly of claim 4 further comprising the step of connecting a computer to the connectors.
